(19) United States
(12) Patent Application Publication
(10) Pub. No.: US 2021/0004871 A1
(43) Pub. Date: Jan. 7, 2021

(54) ADVERTISEMENT GUIDANCE SYSTEM AND ADVERTISEMENT GUIDANCE METHOD

(71) Applicant: NEC PERSONAL COMPUTERS, LTD., Tokyo (JP)

(72) Inventor: Takahisa Shirakawa, Tokyo (JP)

(73) Assignee: NEC PERSONAL COMPUTERS, LTD., Tokyo (JP)

(21) Appl. No.: 16/875,153

(22) Filed: May 15, 2020

(30) Foreign Application Priority Data
Jul. 5, 2019 (JP) 2019125945

(51) Int. Cl. G06Q 30/02

(52) U.S. Cl. CPC G06Q 30/0269; G06Q 30/0277

(57) ABSTRACT

An advertisement guidance system includes: an advertisement database in which plural pieces of advertisement information are so stored that guidance information on each advertisement, feature information on the advertisement, and user target information are associated with one another; an extraction unit which extracts, from the advertisement database, advertisement information having user target information that matches an attribute of a user; an advertisement information storage unit which stores the advertisement information extracted by the extraction unit; a specification unit which specifies advertisement information having feature information on an advertisement contained in viewed content from the advertisement information stored in the advertisement information storage unit; and a display control unit which displays, on a display unit, guidance information on the advertisement included in the specified advertisement information.

### FIELD OF THE INVENTION

The present invention relates to an advertisement guidance system and an advertisement guidance method.

### BACKGROUND OF THE INVENTION

Conventionally, there is known a method for a so-called guided advertisement, in which an advertising search keyword appears on a TV commercial or a street advertisement such as an advertisement in a train to guide users to an advertiser's website. However, since this method requires the users to memorize and enter the search keyword, it is difficult to obtain a desired guidance effect.

Therefore, for example, Japanese Unexamined Patent Application Publication No. 2011-188346 proposes a system in which related advertisement information related to a broadcast program viewed on a television receiver is automatically displayed on a display screen of the television receiver to encourage the purchase of a product.

### SUMMARY OF THE INVENTION

In the method disclosed in Japanese Unexamined Patent Application Publication No. 2011-188346 described above, since the advertisement information is automatically presented, the burden on users is reduced. However, since the related advertisement information is displayed one by one in all viewed programs on the display screen of the television receiver, this may make the users feel bothered, and hence make the users uncomfortable.

Further, since the number of targets (the number of parameters) to be compared with a keyword in a viewed program is enormous, the search-processing load is heavy.

The present invention has been made in view of such circumstances, and it is an object thereof to provide an advertisement guidance system and an advertisement guidance method, capable of reducing the processing load related to advertisement guidance and relieving a user from being bothered with the presentation of excessive information.

An advertisement guidance system according to the first aspect of the present invention includes: an advertisement database in which plural pieces of advertisement information are so stored that guidance information on each advertisement, feature information on the advertisement, and user target information are associated with one another; an extraction unit which extracts, from the advertisement database, advertisement information having user target information that matches an attribute of a user; an advertisement information storage unit which stores the advertisement information extracted by the extraction unit; a specification unit which specifies advertisement information having feature information on an advertisement contained in content viewed or recorded and played back from the advertisement information stored in the advertisement information storage unit; and a display control unit which displays, on a display unit, guidance information on the advertisement included in the specified advertisement information.

An advertisement guidance method according to the second aspect of the present invention is an advertisement guidance method in which a computer executes: a step of extracting, from an advertisement database in which plural pieces of advertisement information are so stored that guidance information on each advertisement, feature information on the advertisement, and user target information are associated with one another, advertisement information having user target information that matches an attribute of a user, and storing the advertisement information in an advertisement information storage unit; a step of specifying advertisement information having feature information on an advertisement contained in viewed content from the advertisement information stored in the advertisement information storage unit; and a step of displaying, on a display unit, guidance information on the advertisement included in the specified advertisement information.

The above-described aspects of the present invention can reduce the processing load related to advertisement guidance and relieve a user from being bothered with the presentation of excessive information.

### BRIEF DESCRIPTION OF THE DRAWINGS

FIG. 1 is an overall configuration diagram illustrating the configuration of an advertisement guidance system according to a first embodiment of the present invention.

FIG. 2 is a schematic configuration diagram illustrating an example of the hardware configuration of an information processing apparatus according to the first embodiment of the present invention.

FIG. 3 is a schematic configuration diagram illustrating an example of the hardware configuration of an advertisement server according to the first embodiment of the present invention.

FIG. 4 is a functional block diagram illustrating functions related mainly to an advertisement guidance function extracted from functions included in the information processing apparatus and the advertisement server in the advertisement guidance system according to the first embodiment of the present invention.

FIG. 5 is a flowchart illustrating an example of the processing procedure of an advertisement information updating process in an advertisement guidance method according to the first embodiment of the present invention.

FIG. 6 is a flowchart illustrating an example of the processing procedure of a guided advertisement providing process in the advertisement guidance method according to the first embodiment of the present invention.

FIG. 7 is a diagram illustrating an example of a guided advertisement providing method according to the first embodiment of the present invention.

FIG. 8 is a functional block diagram illustrating functions related mainly to an advertisement guidance function extracted from functions of an information processing apparatus and an advertisement server in an advertisement guidance system according to a second embodiment of the present invention.

### DETAILED DESCRIPTION OF THE INVENTION

### First Embodiment

An advertisement guidance system and an advertisement guidance method according to a first embodiment of the present invention will be described below with reference to the accompanying drawings.

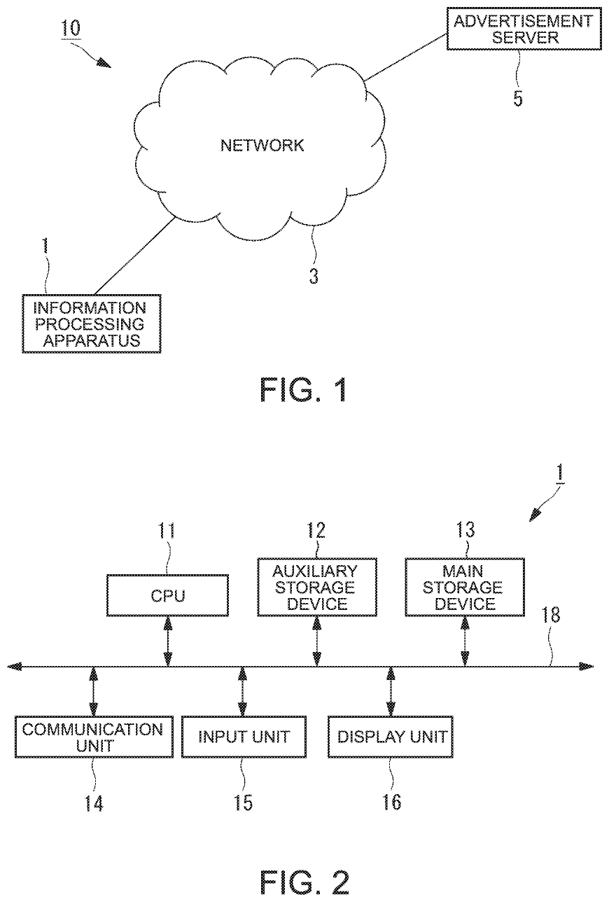

FIG. 1 is an overall configuration diagram illustrating the configuration of an advertisement guidance system 10 according to one embodiment of the present invention. As illustrated in FIG. 1, the advertisement guidance system 10 includes an information processing apparatus 1 and an advertisement server 5. In FIG. 1, one information processing apparatus 1 and one advertisement server 5 are illustrated, but the numbers of respective machines are not limited to those as illustrated, that is, the numbers of respective machines are not particularly limited.

FIG. 2 is a schematic configuration diagram illustrating an example of the hardware configuration of the information processing apparatus 1 according to one embodiment of the present invention. As illustrated in FIG. 2, the information processing apparatus 1 includes, for example, a CPU 11, an auxiliary storage device 12 for storing programs executed by the CPU 11, data referred to by the programs, and the like, a main storage device 13 functioning as a working area upon execution of each program, a communication unit 14 for connection to a network, an input unit 15, a display unit 16, and the like. These units are connected, for example, through a bus 18. Examples of the auxiliary storage device 12 include a magnetic disk such as an HDD (Hard Disk Drive), a magneto-optical disk, and a semiconductor memory such as an SSD (Solid State Drive).

A series of processes to realize various functions to be described later is stored in the auxiliary storage device 12 in the form of a program (for example, an advertisement guidance program) as an example. The various functions are realized by the CPU 11 reading this program into the main storage device 13 and executing information processing/arithmetic processing. Note that the program may be pre-installed on the auxiliary storage device 12, provided in the form of being stored on any other computer-readable storage medium, or distributed through wired or wireless communication. The computer-readable storage medium is a magnetic disk, a magneto-optical disk, a CD-ROM, a DVD-ROM, a semiconductor memory, or the like.

In FIG. 2, the communication unit 14 is connected to a network 3 (see FIG. 1), typified by the Internet, to establish an interface with the network 3. The input unit 15 is a user interface such as a remote control, a keyboard, a mouse, and/or a touch panel to allow a user to give instructions to the information processing apparatus 1. The display unit 16 has a display screen, for example, of an LCD (Liquid Crystal Display), to display the results of an application software program executed on the information processing apparatus 1, content received through the communication unit 14, and the like.

As an example of the information processing apparatus 1, there is a desktop PC, a laptop PC, a tablet terminal, a mobile phone, a television receiver, or the like.

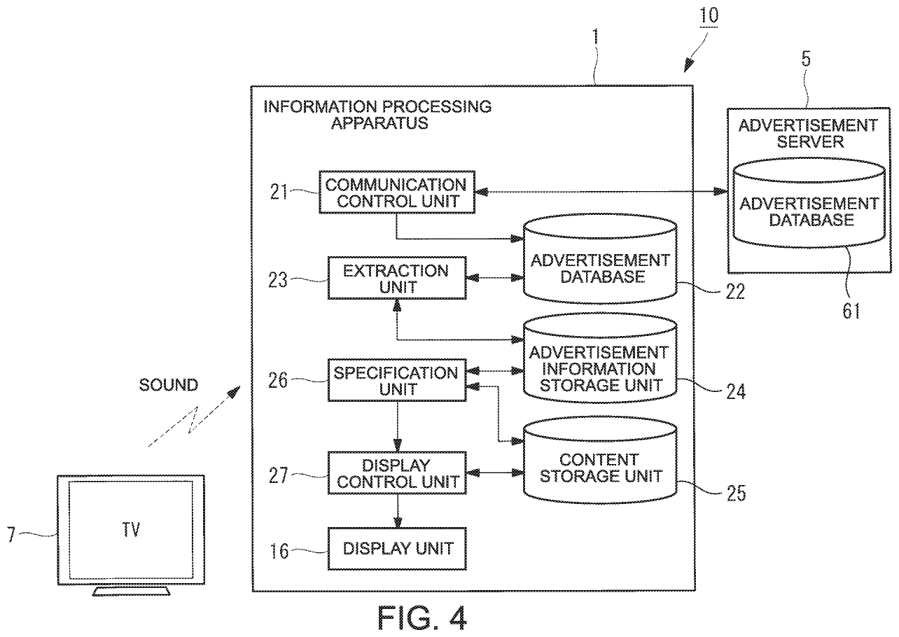

The advertisement server 5 includes an advertisement database 61 (see FIG. 4) in which plural pieces of advertisement information are stored, and provides, to the information processing apparatus 1, all or some pieces of advertisement information stored in the advertisement database 61 upon request from the information processing apparatus 1.

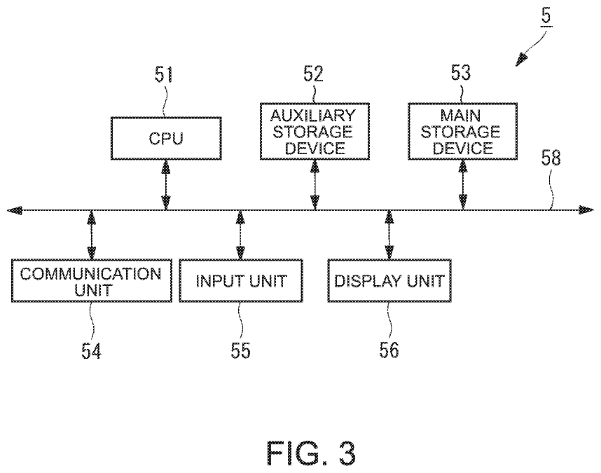

FIG. 3 is a schematic configuration diagram illustrating an example of the hardware configuration of the advertisement server 5 according to the embodiment. As illustrated in FIG. 3, the advertisement server 5 includes, for example, a CPU 51, an auxiliary storage device 52 for storing programs executed by the CPU 51, data referred to by the programs, and the like, a main storage device 53 functioning as a working area upon execution of each program, a communication unit 54 for connection to a network, an input unit 55, a display unit 56, and the like. These units are connected, for example, through a bus 58. Examples of the auxiliary storage device 52 include a magnetic disk such as an HDD (Hard Disk Drive), a magneto-optical disk, a semiconductor memory such as an SSD (Solid State Drive).

A series of processes to realize various functions to be described later is stored in the auxiliary storage device 52 in the form of a program as an example. The various functions are realized by the CPU 51 reading this program into the main storage device 53 and executing information processing/arithmetic processing. Note that the program may be pre-installed on the auxiliary storage device 52, provided in the form of being stored on any other computer-readable storage medium, or distributed through wired or wireless communication. The computer-readable storage medium is a magnetic disk, a magneto-optical disk, a CD-ROM, a DVD-ROM, a semiconductor memory, or the like.

FIG. 4 is a functional block diagram illustrating functions related mainly to an advertisement guidance function extracted from functions included in the information processing apparatus 1 and the advertisement server 5. As illustrated in FIG. 4, the advertisement server 5 includes the advertisement database 61. The information processing apparatus 1 includes a communication control unit 21, an advertisement database 22, an extraction unit 23, an advertisement information storage unit 24, a content storage unit 25, a specification unit 26, a display control unit 27, and the display unit 16.

In the advertisement database 61, plural pieces of advertisement information are so stored that guidance information on each advertisement, feature information on the advertisement, and user target information are associated with one another.

The guidance information on each advertisement (hereinafter called a “guided advertisement”) contains, for example, at least either an advertising video or information for access to information related to the advertisement.

As an example of the advertising video, for example, there is an original advertising video which is TV-broadcast or the content of which is distributed, or a simplified version of the advertising video. As an example of the information for access to the information related to the advertisement, there is a URL (Uniform Resource Locator).

The feature information on the advertisement is, for example, identification information used to specify the advertisement. In the embodiment, description is made by taking as an example a case where advertising code as identification information uniquely assigned to each advertisement is used, but the present invention is not limited to this example. For example, a sound logo or a key phrase of the advertisement can also be used. Further, the feature information on the advertisement is not limited to audio information such as the sound logo of the advertisement, and it may be a feature value of a still image or a video.

Examples of the user target information include the gender, the target age group, the target area, and the advertising category, and at least one of them is registered as the user target information.

The communication control unit 21 of the information processing apparatus 1 accesses the advertisement server 5 at predetermined timing to download the advertisement information stored in the advertisement database 61 and store the advertisement information in the advertisement database 22.

The extraction unit 23 extracts, from the advertisement database 22, advertisement information having user target information that matches the attribute(s) of each user. User attribute information contains at least one of the gender, the age, the residence, and the hobby/taste. Note that the user attribute information is information acquired in advance. More specifically, the user attribute information is information registered by the user or information automatically acquired based on the information on a website browsed by the user, which is stored, for example, in a predetermined storage area of the auxiliary storage device 12.

For example, when the gender, the age, the residence, and the hobby/taste are registered as the user attribute information, the extraction unit 23 extracts, from the advertisement database 22, advertisement information having target information that matches a category according to the gender, the age, the residence, and the hobby/taste, and stores the advertisement information in the advertisement information storage unit 24. Note that the search conditions (AND/OR conditions) when plural pieces of attribute information are registered (for example, gender and age) can be set appropriately. For example, it can be set appropriately whether to extract advertisement information with both the gender and the age matching the target information or to extract advertisement information with either one of the gender and the age matching the target information.

Further, the search conditions can be dynamically changed. For example, in the case where the minimum number of advertisements to be extracted is predetermined, when the number of advertisement information pieces that match all the attribute information pieces (that is, the number of advertisement information pieces extracted by using all the attribute information pieces as AND conditions) is less than the minimum number, the search may be done again by setting any of the items as an OR condition.

The advertisement information extracted by the extraction unit 23 is stored in the advertisement information storage unit 24.

The content storage unit 25 accumulates information related to content viewed by the user. Here, as the “content,” there are a broadcast program from a broadcasting station, a video distributed from a video distribution server, a street advertisement, and the like. Further, the “content viewed” is not limited to content being distributed in real time, and it includes content being played back after recorded. FIG. 4 illustrates a case where the information processing apparatus 1 acquires information on content being viewed by the user through a television receiver 7 and stores information related to the content in the content storage unit 25.

As an example of the “information related to the content” mentioned above, there is the content itself, audio data of the content, identification information on the advertisement (for example, advertising code) added to the content and used to specify the advertisement information included in the content, or the like. The information related to the content may also be information without audio data such as image information or video information.

When identification information on the advertisement is added to the content, the identification information may be added to the content as inaudible sound wave data. Further, the identification information may be encoded. In this case, a function of decoding the identification information has only to be provided in the information processing apparatus 1.

Further, time information indicative of the time when the content was viewed may be associated with the “information related to the content” as additional information.

As the “advertisement included in the content,” for example, there is a commercial in a broadcast program or a distributed video, a product itself (such as a car, a PC, a jewelry, or a bag) used by a character in the broadcast program or the distributed video.

In the embodiment, advertising code assigned to the advertisement included in the content is exemplified as the “information related to the content,” and description is made on the assumption that this advertising code is stored in the content storage unit 25. However, it is selectable what information is adopted as the “information related to the content” stored in the content storage unit 25 appropriately according to the “feature information on the advertisement” included in the advertisement information stored in the advertisement information storage unit 24.

From the advertisement information stored in the advertisement information storage unit 24, the specification unit 26 specifies advertisement information including feature information on the advertisement contained in the content viewed. For example, the specification unit 26 uses, as a key, the advertising code stored in the content storage unit 25 to search the advertisement information stored in the advertisement information storage unit 24 in order to specify advertisement information having the same advertising code as the “feature information on the advertisement.” The advertisement information specified by the specification unit 26 is stored in the advertisement information storage unit 24 in such a manner as to be differentiated from other unspecified pieces of advertisement information. For example, a flag is added to each piece of advertisement information, and the flag of the specified advertisement information may be set to “1” to differentiate it from the other pieces of advertisement information. Further, a guided advertisement included in the specified advertisement information may be extracted and stored in a predetermined storage area.

The timing of specifying the advertisement information by the specification unit 26 can be set appropriately. For example, the specification unit 26 may use, as a specification trigger event, the time when a new piece of information is stored in the content storage unit 25, the time when the display unit 16 is put in a displayable state, or the time when a predetermined application is launched, to specify advertisement information having the advertising code stored in the content storage unit 25 from the advertisement information stored in the advertisement information storage unit 24.

When specifying the advertisement information, for example, the specification unit 26 may target all pieces of information related to the content stored in the content storage unit 25 to specify the advertisement information, or target information related to content viewed after the occurrence of the above-mentioned specification trigger event and before the elapse of a predetermined period to specify the advertisement information. Thus, since the setting of a time constraint enables a guided advertisement related to the content recently viewed by the user to be presented, it can be expected to enhance the advertisement effect. Further, since the number of advertising codes to be checked can be narrowed down, the search-processing load can be reduced.

The display control unit 27 displays, on the display unit 16, a guided advertisement included in the advertisement information specified by the specification unit 26. The timing at which the display control unit 27 displays the guided advertisement on the display unit 16 can be set appropriately. For example, the display control unit 27 displays, on the display unit 16, the guided advertisement included in the advertisement information specified by the specification unit 26 when a pre-registered display trigger event occurs. Here, as an example of the display trigger event in the information processing apparatus 1, there is the time when a predetermined application is launched, the time when the display screen of the display unit 16 is put in a displayable state, or the time when viewing of the content is finished.

Further, for example, in the case where a recorded broadcast program or the like is being played back, the display control unit 27 may provide a display at the timing of skipping a TV commercial, that is, the display control unit 27 may display, on the display unit 16, a guided advertisement of the skipped commercial. In this case, even when the TV commercial is skipped by the user, the guided advertisement of the skipped TV commercial can be provided to the user.

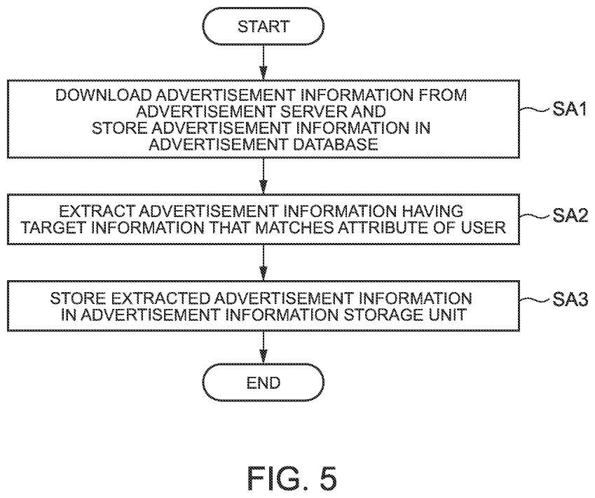

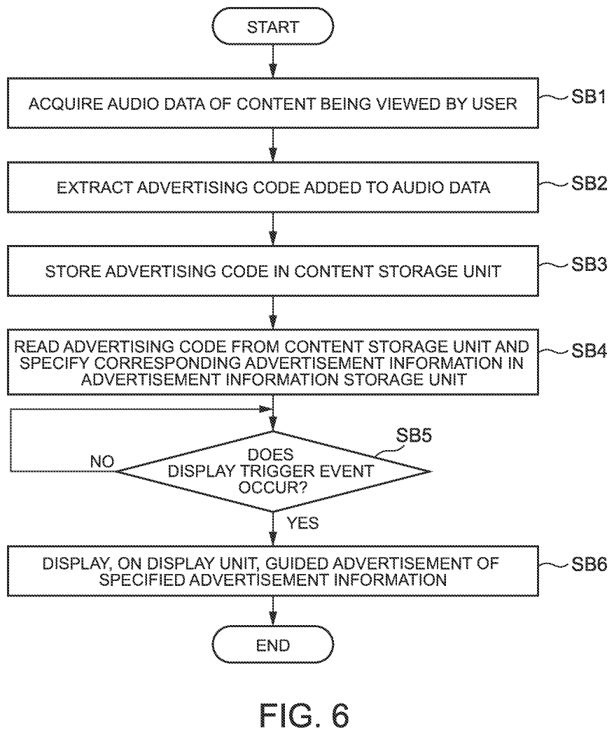

Next, an advertisement guidance method executed by the advertisement guidance system 10 according to the embodiment will be described with reference to FIG. 5 and FIG. 6.

FIG. 5 and FIG. 6 are flowcharts illustrating an example of a processing procedure of the advertisement guidance method according to the embodiment. As illustrated in FIG. 5 and FIG. 6, the advertisement guidance method mainly has two processes, that is, an advertisement information updating process (see FIG. 5) and a guided advertisement providing process (see FIG. 6). The respective processes will be described below with reference to the drawings. Note that the following processes are realized by a processor executing a program stored in a storage unit provided in the information processing apparatus 1.

[Advertisement Information Updating Process]

First, the processor of the information processing apparatus 1 accesses the advertisement server 5, downloads many pieces of advertisement information accumulated in the advertisement database 61 of the advertisement server 5, and stores the downloaded advertisement information in the advertisement database 22 (SA1 in FIG. 5).

Then, the processor of the information processing apparatus 1 extracts, from the many pieces of advertisement information stored in the advertisement database 22, advertisement information having target information that matches the attribute of the user (SA2), and stores the extracted advertisement information in the advertisement information storage unit 24 (SA3). Thus, only the advertisement information having the target information that matches the attribute of the user is stored in the advertisement information storage unit 24.

This advertisement information updating process is performed repeatedly, for example, at predetermined timing or predetermined time intervals. Thus, the advertisement information stored in the advertisement database 22 and the information stored in the advertisement information storage unit 24 are updated at the predetermined timing or predetermined time intervals.

[Guided Advertisement Providing Process]

In the guided advertisement providing process, for example, audio data of the content being viewed or listened by user (for example, a broadcast program, a radio program, a distributed video, or the like) is acquired by a microphone (not illustrated) of the information processing apparatus 1 (SB1 in FIG. 6), and advertising code added to the audio data as inaudible sound wave data is extracted (SB2) and stored in the content storage unit 25 (SB3).

Then, advertisement information specification processing is executed. In this advertisement information specification processing, the advertising code stored in the content storage unit 25 is read, and the advertisement information stored in the advertisement information storage unit 24 is targeted to specify advertisement information having, as the feature information on the advertisement, the same advertising code as the advertising code read from the content storage unit 25 (SB4). As an example, the specified advertisement information is stored in the advertisement information storage unit 24 in such a state as to be differentiated from other pieces of advertisement information (such as that the flag is set to “1”) as described above.

Then, it is determined whether the display trigger event occurs or not (SB5). When it does not occur (SB5: “NO”), the procedure enters a standby state until the display trigger event occurs.

Then, when the display trigger event occurs (SB5: “YES”), a guided advertisement included in the advertisement information specified in the advertisement information specification processing is displayed on the display screen of the display unit 16 (SB6).

For example, as illustrated in FIG. 4, the display screen of the information processing apparatus 1 is not always in the displayable state while the user is viewing a Tv program or the like, and a guided advertisement cannot be presented to the user unless the display screen is in the displayable state. Therefore, it is determined whether the display trigger event occurs or not to determine whether the guided advertisement can be presented to the user or not in order to make sure that the guided advertisement can be presented to the user.

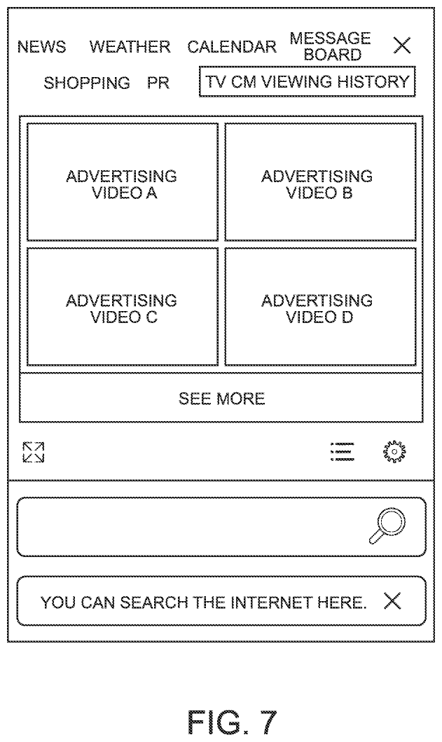

As a result, for example, advertising videos A to D are displayed as guided advertisements on the whole or part of the display unit 16 of the information processing apparatus 1 as illustrated in FIG. 7. Then, the user browses these advertising videos A to D, and when clicking on an advertising video the user has interest in, the user can access a website for a product or a service advertised in the advertising video.

In the guided advertisement providing process, the advertisement information specification processing (SB4) may be executed each time advertising code is stored in the content storage unit 25 or executed when the predetermined specification trigger event occurs. The specification trigger event is as described above.

Further, for example, in the advertisement information specification processing, all pieces of information related to the content stored in the content storage unit 25 may be targeted to specify the advertisement information, or information related to the content viewed after the occurrence of the above-mentioned specification trigger event (or the display trigger event) and before the elapse of the predetermined period may be targeted to specify the advertisement information. Thus, since the setting of the time constraint enables a guided advertisement(s) related to the content recently viewed by the user to be presented, it can be expected to enhance the advertisement effect. Further, since the number of advertising codes to be checked can be narrowed down, the search-processing load can be reduced. Further, in this case, since only information related to content before the elapse of the predetermined period is used for search, the content information corresponding to the period has only to be stored in the content storage unit 25, and this can reduce the amount of data to hold. Thus, the large-capacity content storage unit 25 is no longer needed, enabling reduction in the data capacity and the costs.

As described above, according to the advertisement guidance system 10 and the advertisement guidance method of the embodiment, many pieces of advertisement information are downloaded from the advertisement server 5 in which the many pieces of advertisement information are accumulated, and stored in the advertisement database 22 inside the information processing apparatus 1. Further, advertisement information having target information that matches the attribute of the user is extracted from the many pieces of advertisement information stored in the advertisement database 22, and stored in the advertisement information storage unit 24. Then, since the advertisement information stored in the advertisement information storage unit 24 is targeted to specify advertisement information corresponding to content being viewed by the user, the number of search parameters of advertisement information can be reduced effectively. This can lead to reducing the search-processing load. Further, a guided advertisement(s) to be presented to the user is the guided advertisement(s) that matches the attribute of the user. Therefore, for example, the probability that guided advertisements irrelevant at all to the user will be presented to the user can be reduced to relieve the user from being bothered with the presentation of excessive information.

### Second Embodiment

An advertisement guidance system and an advertisement guidance method according to a second embodiment of the present invention will be described below with reference to a drawing.

In the above-described first embodiment, advertisement information extraction processing for extracting advertisement information that matches the attribute of the user from many pieces of advertisement information downloaded from the advertisement server 5 is performed in the information processing apparatus 1. On the contrary, the advertisement guidance system according to the second embodiment is different from that of the first embodiment in that user attribute information is provided from the information processing apparatus to the advertisement server, the advertisement information extraction processing for extracting an advertisement(s) that matches the attribute of the user is performed on the advertisement server, and the extracted advertisement information, that is, only advertisement information having target information that matches the attribute of the user is downloaded into the information processing apparatus.

The advertisement guidance system and the advertisement guidance method according to the embodiment will be described below. In the following, points different from the above-described first embodiment are mainly described while omitting points common thereto.

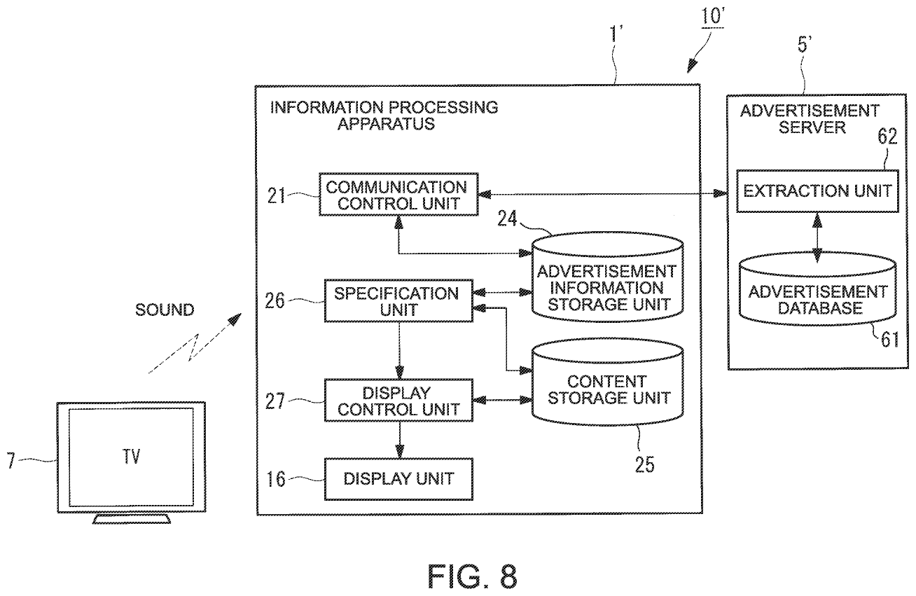

FIG. 8 is a functional block diagram illustrating functions related mainly to an advertisement guidance function extracted from the functions of an information processing apparatus 1′ and an advertisement server 5′ in an advertisement guidance system 10′ according to the second embodiment of the present invention. As illustrated in FIG. 8, the advertisement server 5′ includes the advertisement database 61 and an extraction unit 62. The information processing apparatus 1′ includes the communication control unit 21, the advertisement information storage unit 24, the content storage unit 25, the specification unit 26, and the display control unit 27.

According to this advertisement guidance system 10′, for example, the communication control unit 21 accesses the advertisement server 5′ at predetermined timing to transmit user attribute information to the advertisement server 5′. When receiving the user attribute information, the extraction unit 62 of the advertisement server 5′ extracts, from the advertisement database 61, advertisement information having target information that matches this attribute information, and transmits the extracted advertisement information to the information processing apparatus 1′. When receiving the advertisement information from the advertisement server 5′, the communication control unit 21 stores the received advertisement information in the advertisement information storage unit 24.

Thus, like in the above-described first embodiment, only the advertisement information having the target information that matches the user attribute information is stored in the advertisement information storage unit 24 of the information processing apparatus 1′, and used to present a guided advertisement(s).

As a result, like in the above-described first embodiment, the search-processing load of searching the advertisement information can be reduced. Further, a guided advertisement(s) presented to the user is also the guided advertisement(s) that matches the attribute of the user. Therefore, for example, the probability that guided advertisements irrelevant at all to the user will be presented to the user can be reduced to relieve the user from being bothered with the presentation of excessive information.

While the present invention has been described with reference to each of the embodiments, the technical scope of the present invention is not limited to the description of the above embodiments. Various changes or improvements can be added to the above-described embodiments without departing from the gist of the invention, and embodiments to which the changes or improvements are added are also included in the technical scope of the present invention. Further, the above-described embodiments may be combined appropriately.

Further, the flow of processing described in the above embodiments is just an illustrative example, and an unnecessary step(s) may be deleted, a new step(s) may be added, or the order of processing may be changed without departing from the gist of the present invention.

For example, the case where the user is viewing content through a device (for example, the television receiver 7) different from the information processing apparatus 1 is described in the above embodiments. However, when the information processing apparatus 1 has a function to receive and display content such as a TV tuner, information related to the content being displayed on the display screen of the information processing apparatus 1 may be stored in the content storage unit 25 so that a guided advertisement(s) related to the viewed content is displayed on the display unit 16. In this case, since the content is viewed through the display unit 16, the timing of displaying the guided advertisement(s) can be set arbitrarily. For example, the guided advertisement(s) related to the content may be displayed on a part of the display screen during viewing the content, or the guided advertisement(s) related to the content may be displayed temporarily on a part or the whole part of the display screen after the user finishes viewing the content.

Further, in the above-described embodiments, advertising code is used to match an advertisement contained in content with advertisement information stored in the advertisement information storage unit 24, but information used for matching is not limited to the advertising code. For example, a sound logo or a key phrase contained in the content may be used as “feature information on each advertisement” to perform matching. In this case, audio data of the content is stored in the content storage unit 25, and the feature information on the advertisement included in the advertisement information is the sound logo or the key phrase of the advertisement. Then, the specification unit 26 uses an existing audio matching technique to specify advertisement information having a feature value such as the sound logo or the key phrase from the advertisement information stored in the advertisement information storage unit 24.

Further, any feature value other than the audio data, such as a feature value of a still image or a video can be used as the “feature information on the advertisement.” In this case, video data or still image data of the content is stored in the content storage unit 25. Then, the specification unit 26 uses an existing image matching technique to specify advertisement information having the feature value of the still image or the video from the advertisement information stored in the advertisement information storage unit 24.

1. An advertisement guidance system comprising:
an advertisement database in which plural pieces of advertisement information are stored whereby guidance information on each advertisement information, feature information on each advertisement information, and user target information are associated with one another;
an extraction unit which extracts, from the advertisement database, advertisement information having user target information that matches an attribute of a user;
an advertisement information storage unit which stores the advertisement information extracted by the extraction unit;
a specification unit which specifies advertisement information having feature information on an advertisement contained in content viewed or recorded and played back from the advertisement information stored in the advertisement information storage unit; and
a display control unit which displays, on a display unit, guidance information on an advertisement included in the specified advertisement information.

2. The advertisement guidance system according to claim 1, further comprising
a content storage unit in which information related to the content viewed is accumulated.

3. The advertisement guidance system according to claim 2, wherein
the feature information on the advertisement is identification information used to specify the advertisement, and
the identification information used to specify the advertisement is added to the content.

4. The advertisement guidance system according to claim 2, wherein
the feature information on the advertisement is a sound logo or a key phrase of the advertisement, and
audio data of the content is stored in the content storage unit.

5. The advertisement guidance system according to claim 2, wherein the specification unit specifies the advertisement information when a preset specification trigger event occurs.

6. The advertisement guidance system according to claim 5, wherein the specification unit targets the information related to the content viewed after occurrence of the specification trigger event and before elapse of a predetermined period to specify the advertisement information.

7. The advertisement guidance system according to claim 2, wherein the display control unit displays, on the display unit, the guidance information on the advertisement when a preset display trigger event occurs.

8. The advertisement guidance system according to claim 7, wherein the display trigger event occurs when a predetermined application is launched, when the display unit is put in a displayable state, or when viewing of the content is finished.

9. The advertisement guidance system according to claim 2, wherein, when the content was recorded and is being played back, the display control unit displays, on the display unit, the guidance information on the advertisement when the advertisement contained in the content has been skipped for viewing.

10. The advertisement guidance system according to claim 1, wherein the content contains at least one of a broadcast program broadcast from a broadcast station, a distributed video distributed from a video distribution server, and a street advertisement.

11. The advertisement guidance system according to claim 1, wherein the guidance information on the advertisement information includes at least either one of an advertising video and information used to access information on the advertisement information.

12. The advertisement guidance system according to claim 1, wherein the attribute includes at least one of gender, age, residence, and hobby/taste of the user.

13. The advertisement guidance system according to claim 1, further comprising:
an advertisement server including the advertisement database; and
an information processing apparatus including the extraction unit, the advertisement information storage unit, the specification unit, and the display control unit, and configured to be communicable with the advertisement server,
wherein the information processing apparatus extracts advertisement information having the user target information that matches the attribute of the user from the plural pieces of advertisement information downloaded from the advertisement server, and stores the advertisement information in the advertisement information storage unit.

14. The advertisement guidance system according to claim 1, further comprising:
an advertisement server including the advertisement database and the extraction unit; and
an information processing apparatus including the advertisement information storage unit, the specification unit, and the display control unit, and configured to be communicable with the advertisement server, wherein
the information processing apparatus transmits user attribute information to the advertisement server, and
the advertisement server extracts advertisement information having the user target information that matches the user attribute information received from the information processing apparatus, and transmits the extracted advertisement information to the information processing apparatus.

15. An advertisement guidance method in which a computer executes:
a step of extracting, from an advertisement database in which plural pieces of advertisement information are stored whereby guidance information on each advertisement information, feature information on each advertisement information, and user target information are associated with one another, advertisement information having user target information that matches an attribute of a user, and storing the advertisement information in an advertisement information storage unit;
a step of specifying advertisement information having feature information on an advertisement information contained in viewed content from the advertisement information stored in the advertisement information storage unit; and
a step of displaying, on a display unit, guidance information on the advertisement included in the specified advertisement information.
